(19) United States
(12) Patent Application Publication
(10) Pub. No.: US 2011/0022502 A1
(43) Pub. Date: Jan. 27, 2011

(54) Tax resolution process and system

(75) Inventor: Thomas M. Evans, Scotts Valley, CA (US)

Correspondence Address: William C. Milks, III, Suite 115B, 1000 Elwell Court, Palo Alto, CA, 94303, US

(73) Assignee: TaxLifebiat, Inc.

(21) Appl. No.: 12/804,097

(22) Filed: Jul. 13, 2010

Related U.S. Application Data
(63) Continuation-in-part of application No. 11/516,371, filed on Sep. 5, 2006.

(51) Int. Cl. G06Q 99/00

(52) U.S. Cl. 705/31

(57) ABSTRACT

A tax resolution system and method are disclosed for identifying and implementing solutions to tax delinquency problems. A taxpayer who is delinquent is guided to provide pertinent data and preferences to be analyzed to derive one or more potential solutions to resolve tax problems or plan a future tax strategy. The taxpayer or a tax professional is provided with the data and support information to solve tax problems and prepare documentation to implement potential solutions based on recommendations provided by the tax resolution system and method.

### CROSS-REFERENCE TO RELATED PATENT APPLICATION

This application is a continuation-in-part of U.S. patent application Ser. No. 11/516,371 filed on Sep. 5, 2006, entitled TAX RESOLUTION PROCESS AND SYSTEM

### BACKGROUND OF THE INVENTION

1. Field of the Invention

The present invention relates generally to taxes and, more particularly, to a method and system for the purpose of assisting one or more taxpayers in identifying and implementing solutions to their tax delinquency problems. One preferred embodiment of the present invention provides a method and system for evaluating taxpayer preferences and/or tax-related and other data regarding taxpayers, collecting and analyzing the taxpayer data, and formulating one or more strategies or scenarios to resolve tax delinquency or tax planning problems.

2. References

[1] U.S. Published Application No. 20030061131 for “Automated income tax system.”

[2] U.S. Published Application No. 20050283418 for “System and methodology for processing debt management plans.”

[3] U.S. Published Application No. 20050097033 for “Debt management system.”

[4] U.S. Published Application No. 20050038722 for “Methods, systems, and computer program for processing and/or preparing a tax return and initiating certain financial transactions.”

[5] U.S. Published Application No. 20040199456 for “Method and apparatus for explaining credit scores.”

[6] U.S. Published Application No. 20040172347 for “Determining the occurrence of events using decision trees.”

[7] U.S. Published Application No. 20030217032 for “System and method for providing business strategy and compliance information.”

[8] U.S. Published Application No. 20010044734 for “Method, system, and software for providing tax audit insurance.”

[9] U.S. Published Application No. 20020156710 for “Personal or family accounting and management system.”

[10] U.S. Published Application No. 20050102283 for “System with an interactive, graphical interface for delivery of planning information and consulting materials, research, and compliance information relating to tax or other forms.”

[11] U.S. Pat. No. 6,912,508 for “Method and apparatus for promoting taxpayer compliance.”

[12] U.S. Pat. No. 6,446,048 for “Web-based entry of financial transaction information and subsequent download of such information.”

3. Description of the Prior Art

Today, one of the most challenging recurring problems facing any person or business is the filing of tax returns and the payment of taxes. The tax returns are complicated. In order to efficiently complete tax returns, effective bookkeeping practices are required to collect and analyze data that is entered into the tax returns. The payment of taxes must be timely in order to avoid interest and penalties, but taxes place a budgetary strain on the finances of individuals and businesses alike.

Often, data for completing tax returns is not available or is simply not collected sufficiently early to complete tax returns for filing on a timely basis. Just as often, individuals and business may not have the funds to pay taxes. Other factors such as an illness prevent an individual from filing tax returns or paying taxes, or an event such as a fire or hurricane causes destruction of taxpayer data or intervenes to prevent the timely preparation and filing of tax returns and payment of taxes.

Taxpayers can include an individual(s) and/or small business(es) who are a) delinquent in their U.S. Federal personal income taxes, business income taxes, and/or payroll taxes; b) delinquent in their state personal income taxes, business income taxes, and/or payroll taxes; and/or c) planning the consequences of their estimated future liability for any of these types of taxes. Typically, delinquent taxpayers are either confronted with having to resolve their own tax problems or seeking and paying for the advice and assistance of a tax professional that includes both individuals who are tax advisers and/or preparers and an enterprise(s) employing more than one such individual such as H& R Block, Inc. The time and effort required to address a tax delinquency problem are often considerable, and there is an additional out-of-pocket cost associated with consulting with a tax adviser or preparer to assist with preparation of tax returns and payment of taxes and/or planning for future tax liabilities.

Thus, for all these reasons, it would be desirable to provide a tax resolution method and system which overcome the above problems in approaching tax delinquency problems and provide an objective approach that can formulate one or more potential tax resolutions. It is to this end that the present invention is directed. The various embodiments of the present invention have many advantages by providing a tax resolution method and system to identify and implement solutions for delinquent taxpayers.

### SUMMARY OF THE INVENTION

One embodiment of the tax resolution system and method in accordance with the present invention provides many advantages in resolving tax delinquency problems, which make the tax resolution method and system in accordance with the present invention useful to taxpayers as well as tax professionals advising and assisting delinquent taxpayers. One embodiment of the present invention provides a tax resolution methodology and a system that provide one or more solutions to tax problems relating to delinquent filing of taxes and/or filing of tax returns, as well as future tax planning.

A preferred embodiment of the tax resolution system and method in accordance with the present invention guides a delinquent taxpayer to provide pertinent data and preferences to be analyzed to derive one or more potential solutions to resolve tax problems or plan a future tax strategy. The taxpayer or a tax professional is provided with the data and support information to solve tax problems and prepare documentation to implement potential solutions.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 is a block diagram of one embodiment of the tax resolution system in accordance with the present invention;

FIG. 2 is an overview flowchart of one embodiment of the tax resolution method in accordance with the present invention;

FIG. 3 is a detailed flowchart of taxpayer data input and checking steps shown in FIG. 2;

FIG. 4 is a detailed flowchart of data analysis and generation of solutions steps shown in FIG. 2;

FIG. 5 is a detailed flowchart of solution implementation steps shown in FIG. 2;

FIG. 6 is a detailed flowchart of processing macro recommendations using micro algorithms shown in FIG. 4; and

FIG. 7 is a detailed flowchart of tax strategy mapping steps shown in FIG. 6.

### DETAILED DESCRIPTION OF THE PREFERRED EMBODIMENTS

The present invention is particularly applicable to computer software executed by a computer for resolving tax problems and producing tax resolution strategies, and it is in this context that the preferred embodiments of the present invention will be described. It will be appreciated, however, that the tax resolution method and system in accordance with the present invention have greater utility, since they may be used for other types of problem resolution not specifically described herein. Accordingly, the embodiments of the tax resolution method and system in accordance with the present invention are by way of example only, and are not intended to limit the scope of the present invention to resolution of tax liability, as the principles of the present invention apply generally to resolving strategies for any type of problem.

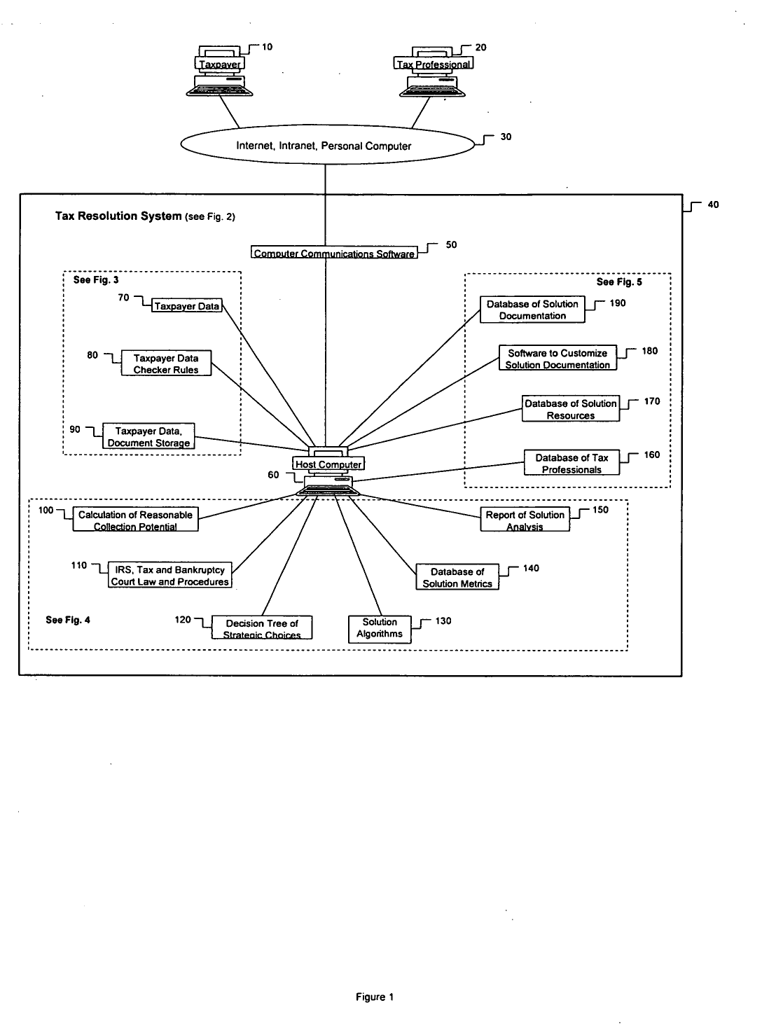

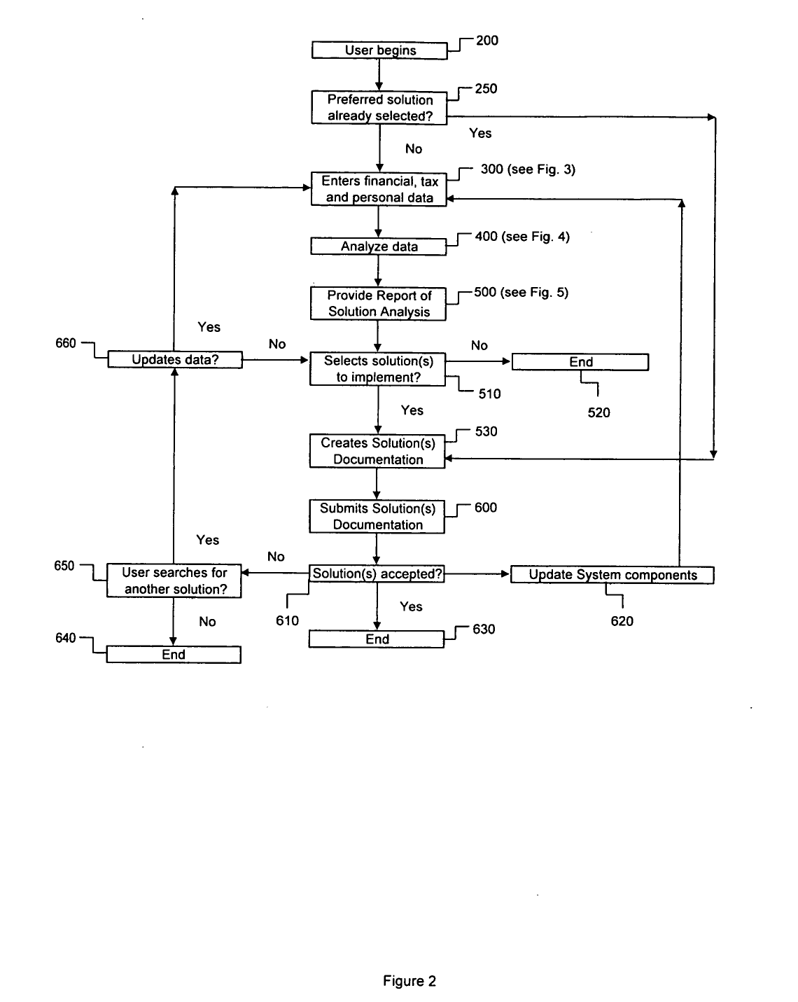

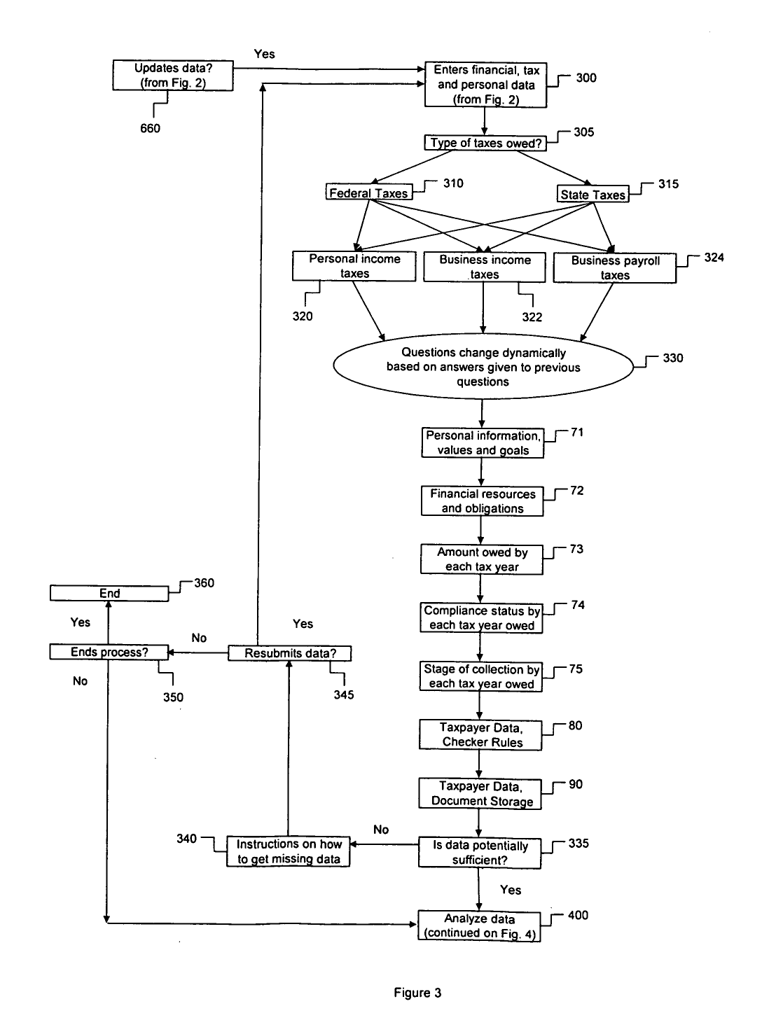

Referring now to the drawing, FIG. 1 shows various components of a preferred embodiment of a tax resolution system 40 in accordance with the present invention. FIG. 2 is an overview flowchart of the tax resolution method in accordance with a preferred embodiment of the present invention performed by the tax resolution system 40. FIGS. 3, 4, and 5 provide more detailed flowcharts of an implementation of various steps of the method shown in FIG. 2.

Generally, the purpose of the tax resolution system 40 is to assist one or more taxpayers 10 in identifying and implementing solutions to their tax delinquency problems. Such taxpayers 10 may include an individual(s) and/or a small business(es) who are a) delinquent in their U.S. Federal personal income taxes, business income taxes, and/or payroll taxes; b) delinquent in their state personal income taxes, business income taxes, and/or payroll taxes; and/or c) planning the consequences of their estimated future liability for any of these types of taxes.

Alternatively or additionally, as shown in FIG. 1, a tax professional 20 may utilize the tax resolution system 40 to identify and implement solutions for taxpayers 10 who are individuals or small businesses a) delinquent in their U.S. Federal personal income taxes, business income taxes, and/or payroll taxes; b) delinquent in their state personal income taxes, business income taxes, and/or payroll taxes; and/or c) planning the consequences of their estimated future liability of any of these types of taxes. A tax professional 20 includes both an individual who is a tax adviser and/or preparer and an enterprise(s) employing more than one such individual.

Hereafter, for convenience, when an action or result applies to either a taxpayer 10 or tax professional 20, they will be collectively referred to as a “user.” In view of the potential interaction between a taxpayer 10 and a tax professional 20, the tax resolution system 40 preferably has built-in safeguards to protect the taxpayer 10, while at the same time providing a platform which enables efficient interaction between a taxpayer 10 and a tax professional 20, as follows.

In one preferred embodiment, a tax professional 20 restricts their involvement to advising on any steps a taxpayer 10 may initiate using the tax resolution system 40. In such an embodiment, the taxpayer 10 may or may not authorize the tax professional 20 to access the taxpayer's 10 secure workspace in a taxpayer data, document storage 90 comprising the tax resolution system 40, as shown in FIG. 1.

In an alternative embodiment, a taxpayer 10 supplies taxpayer data to a tax professional 20. The tax professional 20 then enters the taxpayer data into a secure workspace taxpayer data 70 that the tax professional 20 creates on the tax resolution system 40 on behalf of the taxpayer 10. The tax professional 20 may or may not authorize the taxpayer 10 to access this workspace.

As shown in FIG. 1, a user accesses and interacts with the tax resolution system 40 by a communication medium such as the Internet (including the World Wide Web) or intranet and personal computer 30, or any other electronic techniques and devices that have communication capability with Internet, intranet, or television, for example, such as personal computers, personal data assistants (PDA's), cellular telephones, and other personal communication equipment and computer communications software 50 that interfaces the user and a host computer 60.

The tax resolution system 40 preferably comprises a software application operating on the host computer 60, as shown in FIG. 1. For example, the host computer 60 may be any personal computer having at least 256 megabytes of random access memory (RAM) and preferably includes one gigabyte of RAM. The tax resolution system 40 in accordance with one exemplary implementation of the present invention is a 32-bit software application compatible with a Microsoft Windows 2000 or Windows NT or later operating system available from Microsoft Corporation located in Redmond, Wash. The host computer 60 also preferably comprises a hard disk drive having at least 40 gigabytes of free storage space available. The host computer 60 is provided with the Internet or World Wide Web connection 30 for connection to one or more users. The connection 30 comprises a high-speed connection, for example, a DSL or greater connection, and is preferably a T1 or faster connection. In the preferred embodiment of the tax resolution system 40, users can be ported to the Internet or World Wide Web and analyses and formulation of solutions performed by the host computer 60. In another embodiment of the tax resolution system 40, analyses and formulations of solutions may be preformed by user personal computers 30 associated with users.

As mentioned earlier, the tax resolution system 40 also comprises computer software or code. In the preferred embodiment, the tax resolution system 40 computer software or code can be a hosted application that runs on the host computer 60. In the alternative embodiment, the software or code can comprise a client installed on or downloaded to the personal computers 30 of users and executed locally. Thus, the computer software or code may be initially supplied to users on a CD-ROM or other electronic medium or downloadable over the Internet or World Wide Web.

In accordance with one embodiment of the tax resolution system 40 of the present invention, the software or code preferably comprises other software applications such as word processing and spreadsheet application software. One example of a word processor that can be utilized in the various embodiments of the tax resolution system in accordance with the present invention is Word, and one example of a spreadsheet is Excel, both commercially available from Microsoft Corporation.

The initial action of accessing the tax resolution system 40 is shown as a step 200 (“user begins”) in FIG. 2. The user may have a preferred solution they want to implement using the tax resolution system's 40 resources, as determined by a step 250. In this case, they bypass entering their taxpayer data 70 and go directly to create their solution(s) documentation 550, as indicated by a step 530.

If no solution is initially specified as being preferred, the taxpayer 10 enters their financial, tax, and personal data (taxpayer data 70) into the tax resolution system 40 during a step 300 shown in FIG. 2. This step may comprise a tax professional 20 entering taxpayer data 70 for a taxpayer 10 client. Examples of taxpayer data 70 will be described in more detail shortly. An embodiment of how the step 300 may be implemented is shown in more detail in FIG. 3.

Referring to FIG. 3, the question in a step 305 asks to what agency are the taxes owed: Federal taxes 310 or state taxes 315. Under each of these taxing authorities, the type of taxes owed can be personal income taxes 320, business income taxes 322, or business payroll taxes 324. All six situations are covered by the tax resolution system 40, as well as cases where more than one of these types of taxes is owed. In addition, the tax resolution system 40 preferably provides forecasts of future tax liabilities in deriving tax solutions.

Depending on the answers given by the user to the data input questions, the subsequent questions dynamically adapt, as indicated by a step 330, so that only relevant inquiries are made. For example, if a user states that Federal personal income taxes are the only taxes owed, then subsequent questions asked by the tax resolution system 40 focus on this type of tax.

FIG. 3 depicts the entering of taxpayer data 70 into the tax resolution system 40 in more detail. An additional mode has the user (i.e., a taxpayer 10 or tax professional 20) import the taxpayer data 70 into the tax resolution system 40 from other software programs and databases such as QuickBooks. Specific examples of taxpayer data 70 will be described in more detail below, but, in general, such data may include any or all of the following: personal information, values, and goals 71; financial resources and obligations 72; amount owed by each tax year 73; compliance status by each tax year owed 74; stage of collection by each tax year owed 75, as well as any other data pertinent to resolving their tax problem. The taxpayer data 70 references current and past results or events, as well as future expected results or events. For example, the taxpayer data 70 takes into account if the taxpayer 10 plans to retire soon or incur a significant change in income. This data may be of a personal and/or business nature as well as covering past, current, and future time periods.

Considered in more detail, examples of personal information, values, and goals 71 are the taxpayer's 10 state of health, age, and level of expertise or interest in financial matters, as well as their stated objectives. Examples of financial resources and obligations 72 are the taxpayer's 10 itemization of their monthly income and expenses plus details of their assets and liabilities. Examples of amount owed by each tax year 73 are the taxpayer's 10 liabilities for taxes, interest, and penalties for any tax years for which they are delinquent or expect to owe in the future. Examples of compliance status by each tax year owed 74 are the date tax returns were filed (or if they are still outstanding) and the amount of taxes paid to date (if any) on the unresolved tax years. Examples of stage of collection by each tax year owed 75 are the date and type of notices the taxpayer 10 has received from the tax authority, as well as any levies or liens placed on the taxpayer's 10 income and assets.

An illustrative, limited dataset for a taxpayer 10 may reveal, for example, that they are married with three dependents, 50 years of age, in chronic poor health, with a continual deficit spending of $300.00 per month, $100,000.00 of equity in their home, and having filed no tax returns for the last three years. Their primary goal is to file their past due tax returns and resolve any tax liability that may be owed.

Referring again to FIG. 3, taxpayer data checker rules 80 analyze the taxpayer data 70 for potential completeness and consistency, as indicated by a step 335. A case where a notice of potentially inconsistent would be given the user is when the taxes being withheld exceed the taxpayer's 10 income.

The minimum dataset required changes dynamically as responses are entered by the user. For example, placing a high value on not paying any more to resolve past tax liabilities changes the amount of information needed by the tax resolution system 40, because some solutions (e.g., negotiate an installment plan) are presented in less detail for consideration. If the user later amends their goals to allow additional tax payments, then the taxpayer data checker rules 80 will require more data to be input by the user.

If the taxpayer data is not sufficient to process, the tax resolution system 40 informs the user what data is needed and gives instructions on how to obtain the missing data 340. Such advice could include, for example, sample Internal Revenue Service (hereafter, the “IRS”) or other forms showing where the data is provided and/or a list of professionals who can help assemble the taxpayer data 70.

In one embodiment, the taxpayer data checker rules 80 are used in the step 335 to alert the user as to which possible solutions cannot be analyzed in detail due to insufficient data. The user would then have the option of having the tax resolution system continue to analyze data, as indicated by a step 400, and be given a more limited analysis, or to exercise the option of acquiring more data for resubmission as indicated by a step 345.

At any time the user is connected to the tax resolution system 40, they can save their taxpayer data 70 (FIG. 1) in their individual secure workspace in the taxpayer data, document storage 90. In the implementation illustrated in FIG. 3, for example, the user saves their data after the taxpayer data checker rules 80 have been applied in a step 90. This allows the user to later re-enter the tax resolution system 40 and access the taxpayer data 70. Alternatively, the user can exit the tax resolution system 40 without saving their data or changes to the data.

Preferably, each time the user logs onto the tax resolution system 40, they will be asked if their data needs to be updated and, if so, given the opportunity to do so. In one embodiment, automatic alerts may be scheduled and provided by the tax resolution system 40 to the user respecting when to enter data, file documents, respond to statutory or other deadlines, or take certain other actions. Such notices are preferably communicated utilizing any of the methods and devices described earlier including Internet, intranet, or television via personal computers, personal data assistants (PDA's), cellular telephones, and other personal communication equipment such as by email or text message, for example.

In the step 345, the user is asked if they want to resubmit updated taxpayer data for the taxpayer data 70 or to end the process. Thus, a step 350 provides the choice of ending (indicated by a step 360) or continuing with the limited set of data they have provided (indicated by a step 400). If they resubmit, the cycle of updating the data and having it checked for completeness and consistency repeats until sufficient data is available to analyze, they choose to stop altogether, or they elect to proceed with what data they have already provided, as indicated by the step 400.

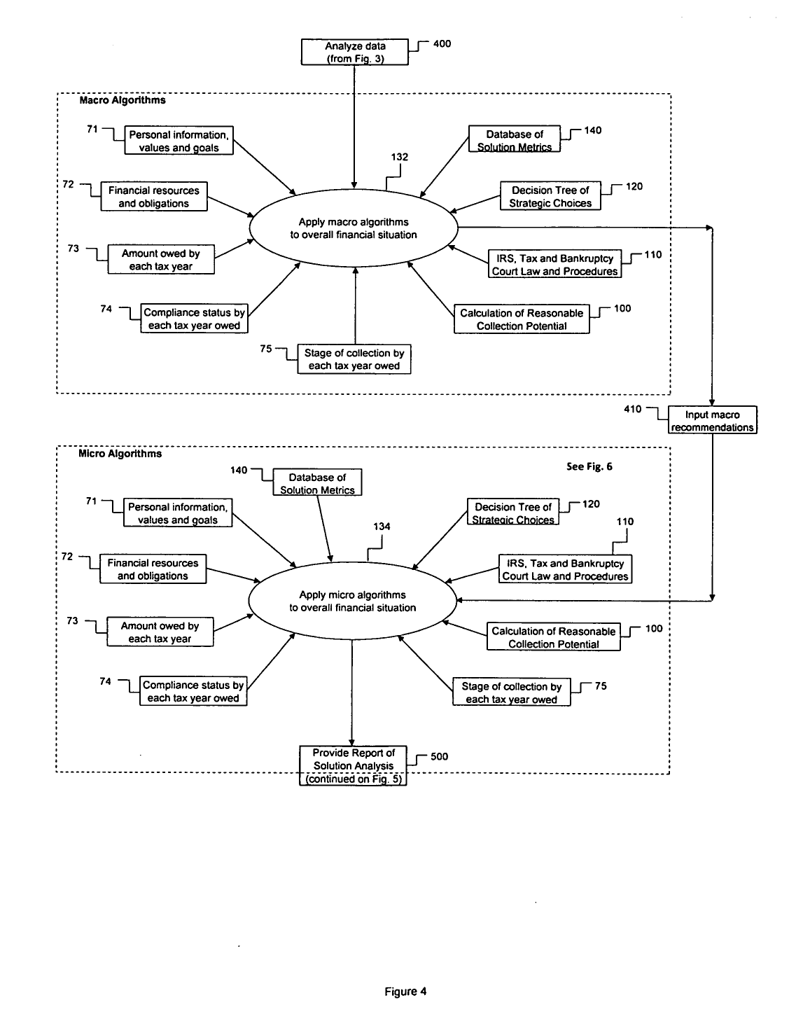

Assuming the taxpayer data checker rules 80 find the data to be potentially sufficient in the step 335 or the user decides to continue with a limited dataset, the tax resolution system 40 then analyzes the data starting with the step 400, which is continued from the bottom of FIG. 3 to the top of FIG. 4.

One embodiment of the analysis process is shown in more detail in FIG. 4. As shown in FIG. 4, macro algorithms 132 and micro algorithms 134 comprise the solution algorithms 130 in FIG. 1.

For example, algorithms weigh the taxpayer data 70 so that some data is given greater importance by the tax resolution system 40 in analyzing the taxpayer's 10 situation and formulating potential solutions. One example is where past tax returns have not been filed. Normally such a situation precludes the IRS from entering into negotiations with delinquent taxpayers, which limits the potential solutions available to the taxpayer 10. The weighting is preferably dependent on the relative desirability of their various goals specified when the user enters personal information, values, and goals 71. This information is incorporated into the weights given alternative solutions. For example, placing a high value on not paying any more to resolve past tax liabilities weights the alternative solutions, because some solutions (e.g., negotiate an installment plan) are weighted less for consideration.

As shown in FIG. 4, the macro algorithms 132 are applied to the taxpayer data 70 to gain a perspective on the taxpayer's overall situation. The macro algorithms 132 preferably utilize all aspects of the taxpayer data 70: personal information, values, and goals 71, financial resources and obligations 72, amount owed by each tax year 73, compliance status by each tax year owed 74, stage of collection by each tax year owed 75, as well as any other data pertinent to resolving their tax problem. Again, examples of personal information, values, and goals 71 are the taxpayer's 10 state of health, age, and level of expertise or interest in financial matters, as well as their stated objectives. Examples of financial resources and obligations 72 are the taxpayer's 10 itemization of their monthly income and expenses plus details of their assets and liabilities. Examples of amount owed by each tax year 73 are the taxpayer's 10 liabilities for taxes, interest, and penalties for any tax years for which they are delinquent or expect to owe in the future. Examples of compliance status by each tax year owed 74 are the date tax returns were filed (or if they are still outstanding) and the amount of taxes paid to date (if any) on the unresolved tax years. Examples of stage of collection by each tax year owed 75 are the date and type of notices the taxpayer 10 has received from the tax authority, as well as any levies or liens placed on the taxpayer's 10 income and assets.

Additionally, as shown in FIG. 4, the macro algorithms 132 preferably take into consideration the “calculation of reasonable collection potential” 100, the IRS, Tax, and bankruptcy court law and procedures 110, the decision tree of strategic choices 120, and the database of solution metrics 140.

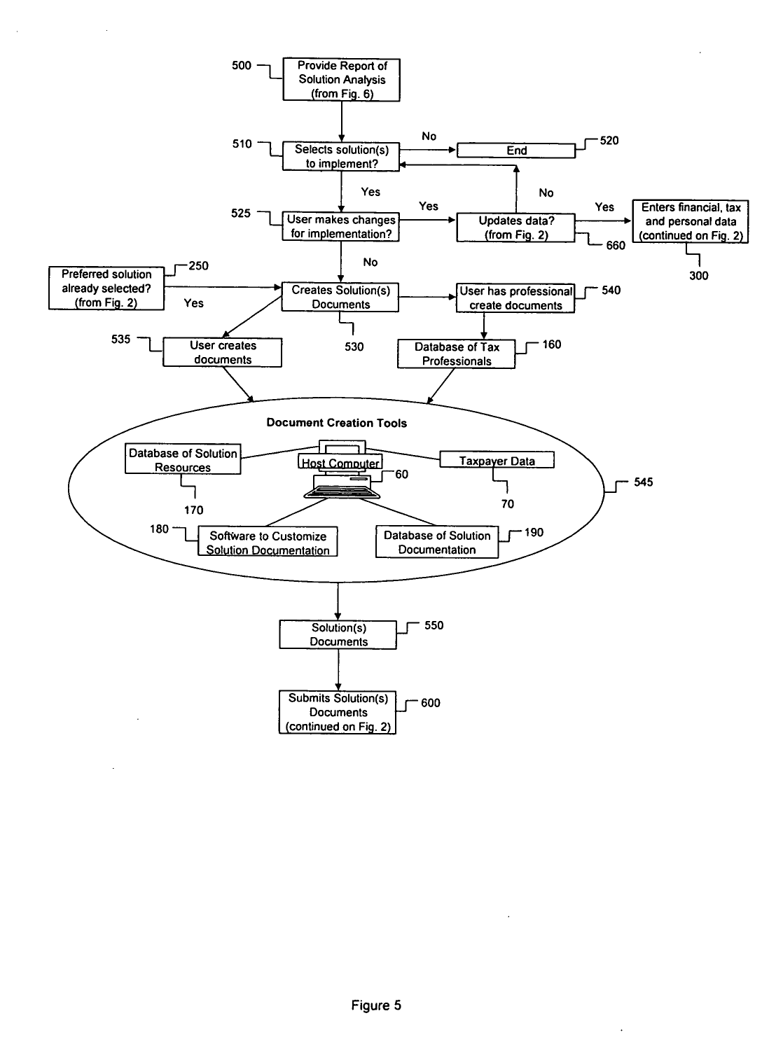

The “calculation of reasonable collection potential” 100 is a quantitative methodology used by the IRS to estimate a taxpayer's 10 ability to pay current and back taxes. For example, cash in the bank and income above allowable limits are assumed to be available for the payment of taxes. This calculation changes as the taxpayer data 70 is amended and the taxpayer 10 makes changes to their financial situation, as indicated by a step 525 shown in FIG. 5. For instance, selling stocks worth $1,000.00 and using the money to reduce bank loans reduces the calculation of reasonable collection potential 100 by $1,000.00.

The calculation of reasonable collection potential 100 is an instance where complete and consistent taxpayer data 70 is required to produce meaningful results. The tax resolution system 40 will prompt the user when the taxpayer data 70 appears to be incomplete and/or inconsistent. As described earlier, the user can make choices about data deficiencies in accordance with the step 345 shown in FIG. 3.

Referring again to FIG. 4, examples of IRS, Tax, and bankruptcy court law and procedures 110 include data related to the probability that different types of cases would be decided in the taxpayer's 10 favor under the jurisdiction of each of these institutions. Preferably, the IRS, Tax, and bankruptcy court law, rules, and procedures are updated whenever changes in the law, rules, or procedures occur so that they are current.

The decision tree of strategic choices 120 starts at very fundamental criteria (e.g., “Does the taxpayer's 10 total liabilities exceed their assets?”) and progresses to lesser priorities (e.g., “How can the taxpayer 10 influence the calculation of reasonable collection potential 100?”). Another embodiment of the decision tree of strategic choices 120 is a mapping of the actions and reactions that are possible between the taxpayer 10 and the IRS, courts, and other institutions, as will be described in more detail shortly.

Examples of the database of solution metrics 140 are estimates of the time, expertise, cost, and other parameters associated with implementing various solutions.

The recommendations from applying the macro algorithms 132 are input to the micro algorithms 134 for analysis, as indicated by a step 410. Factors considered at this stage include all aspects of the taxpayer data 70 (items 71 through 75), as well as the calculation of reasonable collection potential 100, the IRS, Tax, and bankruptcy court law and procedures 110, the decision tree of strategic choices 120, and the database of solution metrics 140. The micro algorithms 134 analyze each delinquent tax year separately to derive recommendations and solutions at that level.

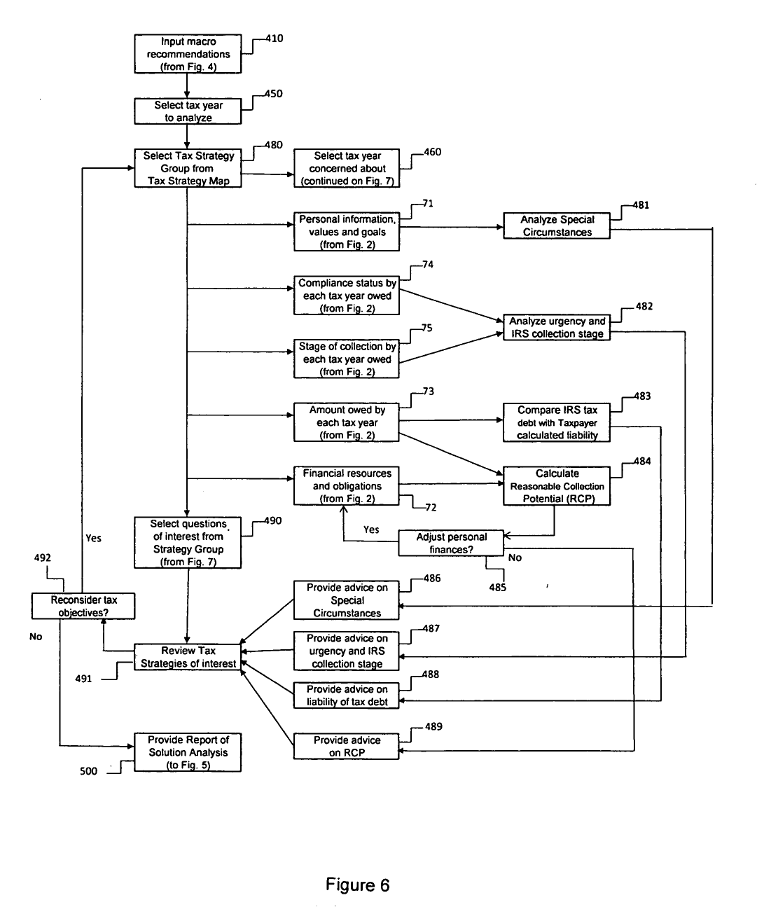

Considered in more detail, the macro recommendations aggregated in step 410 shown in FIG. 4 are parsed in a step 450 shown in FIG. 6, in which the user selects a tax year to be analyzed. After a given tax year is selected for analysis in step 450, the tax resolution system 40 then selects a group of potential tax strategies from a tax strategy map, as indicated by a step 480 shown in FIG. 6. As indicated by a step 460 shown in FIG. 6, the particular group of potential tax strategies is dependent upon a selected tax year about which the user is concerned.

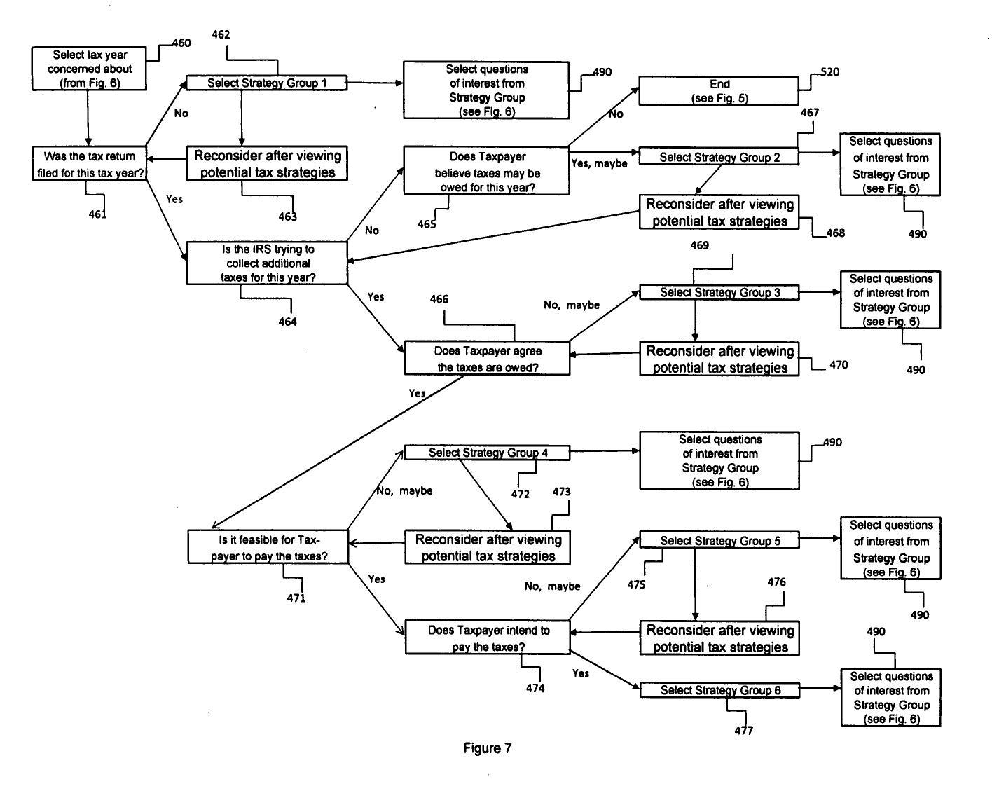

Referring to FIG. 7, after the given tax year about which the user is concerned is selected, a step 461 shown in FIG. 7 determines whether or not a tax return was filed for that tax year. On the one hand, if a tax return was not filed, a first group of potential tax strategies (i.e., Strategy Group 1) is selected, as indicated by a step 462, and applicable questions pertaining to the first strategy group are selected in a step 490 shown in FIG. 6. After reviewing Strategy Group 1 potential tax strategies, in step 463 the taxpayer 10 may reconsider their answer to the question in step 461.

On the other hand, if a tax return was filed for the given tax year, a step 464 shown in FIG. 7 determines whether or not the taxing authority, for example, the IRS, is attempting to collect additional taxes for that year. If not, a step 465 determines whether or not the taxpayer 10 believes taxes are owed for the given tax year, and, if not, applicable questions are selected in a step 490 shown in FIG. 6. Conversely, if the taxpayer 10 believes taxes are owed or may be owed for the given tax year, a second group of potential tax strategies (i.e., Strategy Group 2) is selected, as indicated by a step 467, and applicable questions pertaining to the second group of potential tax strategies are selected in step 490 shown in FIG. 6. After reviewing Strategy Group 2 potential tax strategies, in step 468 the taxpayer 10 may reconsider their answer to the question in step 464.

If step 464 determines that the taxing authority is attempting to collect additional taxes for the given tax year, a step 466 shown in FIG. 7 determines whether or not the taxpayer 10 agrees that the additional taxes sought by the taxing authority are owed for that year. If the taxpayer 10 does not believe or is uncertain whether additional taxes are owed, a third group of potential tax strategies (i.e., Strategy Group 3) is selected, as indicated by a step 469, and applicable questions pertaining to the third group of potential tax strategies are selected in a step 490 shown in FIG. 6. After reviewing Strategy Group 3 potential tax strategies, in step 470 the taxpayer 10 may reconsider their answer to the question in step 466.

Conversely, if step 466 determines that the taxpayer agrees that additional taxes sought by the taxing authority for the given tax year are owed, a step 471 determines whether or not the taxpayer is capable of paying all or part of the additional taxes. On the one hand, if the taxpayer 10 cannot pay or is uncertain that they can pay, a fourth group of potential tax strategies (i.e., Strategy Group 4) is selected, as indicated by a step 472, and applicable questions pertaining to the fourth group of potential tax strategies are selected in a step 490 shown in FIG. 6. After reviewing Strategy Group 4 potential tax strategies, in step 473 the taxpayer 10 may reconsider their answer to the question in step 471.

On the other hand, if step 471 determines that the taxpayer 10 is capable of paying the additional taxes, step 474 determines whether or not the taxpayer 10 intends to pay them. If not or if the taxpayer 10 is uncertain about paying the additional taxes, a fifth group of potential tax strategies (i.e., Strategy Group 5) is selected, as indicated by a step 475, and applicable questions pertaining to the fifth group of potential tax strategies are selected in a step 490 shown in FIG. 6. After reviewing Strategy Group 5 potential tax strategies, in step 476 the taxpayer 10 may reconsider their answer to the question in step 474.

Conversely, if the taxpayer 10 intends to pay the additional taxes, a sixth group of potential tax strategies (i.e., Strategy Group 6) is selected, as indicated by a step 477, and applicable questions pertaining to the sixth group of potential tax strategies are selected in a step 490 shown in FIG. 6.

Referring again to FIG. 6, the applicable questions pertaining to the selected strategy group are provided by the step 490 to a step 491 for review of the questions and associated tax strategies under consideration. For example, the following Table 1 lists questions and tax strategies pertaining to Strategy Group 1 in accordance with one example embodiment of the present invention:

### Table 1

### Example

### Strategy Group 1

### Taxpayer 10 Status

You haven't filed your tax return for this tax year. You may or may not know how much you owe or if you have to file at all.

### Primary Issues to Resolve (and Strategies to do so)

What income is taxable?
Estimate Your Taxable Income and Tax Liability
Know the Consequences of Underreporting Income to the IRS
Determine If You Have to File a Tax Return
Use the Three-Year Statute of Limitations for Taxes
Use the Six-Year Statute of Limitations for Taxes
Present and Substantiate Tax Arguments
Prepare Your Own Tax Return
Use Online Tax Services and Computer Programs
Understand and Use the Taxpayer Bill of Rights
Locate and Use Low-Income Taxpayer Clinics
Have a Tax Professional Prepare Your Tax Return

How can I get my IRS tax records?
Call the IRS Help-Lines for Assistance
Request and Analyze Your IRS Tax Transcripts
Request Your IRS Files under the Freedom of Information Act
Analyze Your IRS Notices and Tax Files
Understand and Use the Taxpayer Bill of Rights
Locate and Use Low-Income Taxpayer Clinics
Locate and Use Tax Clinics for the Elderly

Do I need to file a tax return?
Determine If You Have to File a Tax Return
File Even If You Cannot Pay
Protect Yourself in an IRS Financial Status Audit
Estimate Your Taxable Income and Tax Liability
Avoid Having the IRS File a Tax Return for You
File Delinquent Tax Returns

What is likely to happen if I don't file or don't pay?
Compare Paying the Tax versus Other Alternatives
File Even If You Cannot Pay
File Delinquent Tax Returns
Avoid Having the IRS File a Tax Return for You
Defend Yourself against an IRS Criminal Investigation
Understand the Consequences of Becoming a Tax Protestor or Resister
Know the IRS' Sources of Information about You
Test Your Abilities to Engage with the IRS
Understand the Consequence of Underreporting Assets to the IRS
Understand the Consequence of Willfully Misleading the IRS
Understand and use your Fifth Amendment rights

Can I hide and is the IRS likely to find me?
Know the IRS's Sources of Information about You
Know the Consequences of Underreporting Assets to the IRS
Defend Yourself against an IRS Criminal Investigation
Know the Consequences of Moving to Avoid the IRS
Know the Consequences of Leaving the U.S. to Avoid Taxes
Know the Consequences of Renouncing Citizenship to Avoid Taxes
Avoid Having the IRS File a Tax Return for You
Know the Consequences of Underreporting Income to the IRS
Determine If You Have to File a Tax Return
Understand the Consequences of Becoming a Tax Protestor or Resister
Test Your Abilities to Engage with the IRS
Understand the Consequences of Willfully Misleading the IRS
Compare Paying the Tax versus Other Alternatives

What are the consequences of being a tax protester?
Compare Paying the Tax versus Other Alternatives
Know the Consequences of Being a Tax Protester or Resister
Know the Consequences of Underreporting Income to the IRS
Defend Yourself against an IRS Criminal Investigation
Avoid Having the IRS File a Tax Return for You
Know the Consequences of Moving to Avoid the IRS
Know the Consequences of Leaving the U.S. to Avoid Taxes
Know the Consequences of Renouncing Citizenship to Avoid Taxes
Test Your Abilities to Engage with the IRS
Understand the Consequences of Willfully Misleading the IRS
Know the Consequences of Underreporting Assets to the IRS
Understand and use your Fifth Amendment rights
Know the IRS's Sources of Information about You

How far back to I need to file my delinquent tax returns?
File Delinquent Tax Returns
Use the Three-Year Statute of Limitations for Taxes
Analyze Your IRS Notices and Tax Files
Research Your IRS Records and Tax Issues Strategies
Determine If You Have to File a Tax Return
File Even If You Cannot Pay
Compare Paying the Tax versus Other Alternatives

How do I prepare my tax return?
Gather, Organize and Retain Your Tax Records
Reconstruct or Estimate Your Tax and Financial Data
Reduce Your Tax Liability on Your Tax Return
Cope with the Alternative Minimum Tax
Prepare Your Own Tax Return
Use Online Tax Services and Computer Programs
Avoid Common Tax Return Filing Errors
Minimize Your Chance of an IRS Audit
Obtain an Extension to File Your Tax Return
Consult with a Tax Professional
Locate and Use Low-Income Taxpayer Clinics
Have a Tax Professional Prepare Your Tax Returns
Locate and Use Tax Clinics for the Elderly
Use Circumstantial Evidence to Prove Your Deductions
Reconstruct Your Auto Mileage Log
Know When Complex Tax Issues Require Professional Help

How do I document and support my tax arguments?
Gather, Organize and Retain Your Tax Records
Reconstruct or Estimate Your Tax and Financial Data
Reconstruct Your Auto Mileage Log
Present and Substantiate Tax Arguments
Value Your Property for Tax Purposes
Use Circumstantial Evidence to Prove Your Deductions
Know When Complex Tax Issues Require Professional Help
Consult with a Tax Professional
Complete IRS Financial Disclosure Forms
Manage Your Reasonable Collection Potential
Handle Oral Communications with the IRS
Handle Written Communications with the IRS
Qualify for Special Circumstances Leniency
When It Comes to Taxes, the Burden of Proof Is Often on You
Understand and Use Your Fifth Amendment Rights
Understand and Use the Taxpayer Bill of Rights
Request and Analyze Your IRS Tax Transcripts
Analyze Your IRS Notices and Tax Files
Understand the Consequences of Willfully Misleading the IRS
Know the IRS' Sources of Information about You

Where can I get help to prepare my taxes?
Use Online Tax Services and Computer Programs
Have a Tax Professional Prepare Your Tax Returns
Consult with a Tax Professional
Locate and Use Tax Clinics for the Elderly
Locate and Use Low-Income Taxpayer Clinics
Research Tax Issues and Questions
Know When Complex Tax Issues Require Professional Help

How can I minimize the probability of being audited?
Minimize Your Chance of an IRS Audit
Understand Common Deductions and Expense Ratios
Avoid Common Tax Return Filing Errors
Protect Yourself in an IRS Financial Status Audit
Cope with the Alternative Minimum Tax
Use Online Tax Services and Computer Programs
Have a Tax Professional Prepare Your Tax Returns
Reconstruct or Estimate Your Tax and Financial Data
Reconstruct Your Auto Mileage Log
Avoid Having the IRS File a Tax Return for You
Use Circumstantial Evidence to Prove Your Deductions

What options do I have to pay the taxes?
Pay Back Taxes without Obtaining IRS Permission
Budget Your IRS Tax Payment
Designate Your IRS Tax Payments
Use a Using Guaranteed Installment Agreement to Pay over 36 Months
Use a Streamlined Installment Agreement to Pay over 60 Months
Negotiate a Monthly IRS Tax Payment
Pay the IRS Using Paycheck Deductions
Obtain a Short-Term Installment Plan to Pay Your Taxes
Make Tax Payments until the Ten-Year Statute Expires

What if I can't pay the taxes?
File Even If You Cannot Pay
Compare Paying the Tax versus Other Alternatives
Analyze Your Finances for a Potential Bankruptcy Filing
Make Tax Payments until the Ten-Year Statute Expires
Qualify for IRS Hardship Status
Use the Innocent Spouse Defense
Budget Your IRS tax payments
Negotiate a Monthly IRS Tax Payment
Pay the IRS Using Paycheck Deductions
Obtain Tax Amnesty
Respond to IRS 30-Day and 90-Day Letters
Use Offer in Compromise to Negotiate Your Tax Debt
Know What Assets and Income Are Exempt from IRS Seizure
Understand the Consequences of Becoming a Tax Protestor or Resister

What can I do to protect my assets and credit rating at this stage?
Protect Assets by Creating a Trust
Transfer Assets to Family Members
Know the Consequences of Underreporting Assets to the IRS
Understand Why the Homestead Exemption May Not Protect You
Incorporate Your Business to Save Taxes
Use Limited Partnerships for Tax Advantages
Analyze Your Finances for a Potential Bankruptcy Filing
Know When Complex Tax Issues Require Professional Help
Use Retirement Plans to Save Taxes
Make Tax Payments until the Ten-Year Statute Expires
Qualify for IRS Hardship Status
Use Offer in Compromise to Negotiate Your Tax Debt
Know What Assets and Income Are Exempt from IRS Seizure
Understand the Consequences of Becoming a Tax Protestor or Resister
Understand the Consequences of Willfully Misleading the IRS

What's the IRS's perspective and goals with taxpayers in my situation?
Anticipate IRS Actions and Strategies
When It Comes to Taxes, the Burden of Proof Is Often on You
Understand and Use the Taxpayer Bill of Rights
Analyze Your IRS Notices and Tax Files
Complete IRS Financial Disclosure Forms
Manage Your Reasonable Collection Potential
Consult with a Tax Professional
Know When Complex Tax Issues Require Professional Help
Know the IRS' Sources of Information about You

### Secondary Issues to Consider (and Strategies to do so)

How do I interpret IRS notices I've received?
Analyze Your IRS Notices and Tax Files
Respond to IRS 30-Day and 90-Day Letters
Consult with a Tax Professional
Know When Complex Tax Issues Require Professional Help
Locate and Use Low-Income Taxpayer Clinics
Locate and Use Tax Clinics for the Elderly
Request and Analyze Your IRS Tax Transcripts
Research Tax Issues and Questions
Understand and Use the Taxpayer Bill of Rights
Request Your IRS Files under the Freedom of Information Act
Call the IRS Help-Lines for Assistance

What should I do about the IRS letters and notices I've received?
Test Your Abilities to Engage with the IRS
Analyze Your IRS Notices and Tax Files
Respond to IRS 30-Day and 90-Day Letters
Consult with a Tax Professional
Know When Complex Tax Issues Require Professional Help
Locate and Use Low-Income Taxpayer Clinics
Locate and Use Tax Clinics for the Elderly
Request and Analyze Your IRS Tax Transcripts
Research Tax Issues and Questions
Understand and Use the Taxpayer Bill of Rights
Request Your IRS Files under the Freedom of Information Act
Call the IRS Help-Lines for Assistance
Complete IRS Financial Disclosure Forms
Manage Your Reasonable Collection Potential
Know the IRS' Sources of information about You

What can I do if I miss an IRS deadline?
Appeal to Taxpayer Advocate Service
Remedy Missed IRS Deadlines
Respond to IRS 30-Day and 90-Day Letters
Analyze Your IRS Notices and Tax Files
Request and Analyze Your IRS Tax Transcripts
Anticipate IRS Actions and Strategies

How should I best communicate with the IRS?
Handle Oral Communications with the IRS
Handle Written Communications with the IRS
Respond to IRS 30-Day and 90-Day Letters
Analyze Your IRS Notices and Tax Files
Understand the Consequences of Willfully Misleading the IRS
Know the IRS' Sources of Information about You
Know What Documents to Bring (and Not Bring) to an Audit
Know What to Say (and Not Say) to an Auditor
Complete IRS Financial Disclosure Forms
Present and Substantiate Tax Arguments
Know When Complex Tax Issues Require Professional Help
Understand and Use Your Fifth Amendment Rights
Understand and Use the Taxpayer Bill of Rights
Do Not Rely on Tax Professional-Client Privilege
Understand and Use Attorney-Client Privilege

Do I have the temperament and skills to engage with the IRS?
Test Your Abilities to Engage with the IRS
Know When Complex Tax Issues Require Professional Help
Understand and Use Your Fifth Amendment Rights
Understand and Use the Taxpayer Bill of Rights
Do Not Rely on Tax Professional-Client Privilege
Understand and Use Attorney-Client Privilege
Understand the Consequences of Willfully Misleading the IRS
Know the IRS' Sources of Information about You
Analyze Your IRS Notices and Tax Files
Handle Oral Communications with the IRS
Handle Written Communications with the IRS

What are my legal rights as a taxpayer?
Understand and Use the Taxpayer Bill of Rights
Do Not Rely on Tax Professional-Client Privilege
Understand and Use Attorney-Client Privilege
When It Comes to Taxes, The Burden of Proof Is Often on You
Understand and Use Your Fifth Amendment Rights
Request Your IRS Files under the Freedom of Information Act
Request and Analyze Your IRS Tax Transcripts
Defend Yourself against an IRS Criminal Investigation
Know the IRS' Sources of Information about You
Understand the Consequences of Willfully Misleading the IRS
Understand the Consequences of Becoming a Tax Protestor or Resister
Know the Consequences of Leaving the US to Avoid the IRS
Know the Consequences of Renouncing Citizenship to Avoid Taxes
Analyze Your Finances for a Potential Bankruptcy Filing
Sue the IRS for Wrongful Collection and Enforcement Actions
Sue the IRS in the Court of Federal Claims
Sue an IRS Employee Who Intentionally Disregards the Law
Sue the IRS in Tax Court
Sue the IRS in US District Court
Use the Three-Year Statute of Limitations for Taxes
Use the Ten-Year Statute of Limitations for Taxes
Use the Six-Year Statute of Limitations for Taxes

As will be apparent to persons skilled in the art, the questions associated with Strategy Group 1 shown in Table 1 are dependent on the situation in which the taxpayer 10 finds themselves, specifically, the taxpayer has not filed a tax return for the given tax year. The potential solutions, namely, the available responses to the questions that are posed to the taxpayer 10, are targeted at dealing with the identified situation and are based on the circumstances of the taxpayer and the IRS, Tax, and bankruptcy court law, rules, and procedures that apply to the situation, which, as described earlier, may change from time to time. Based on the example set forth for Strategy Group 1 shown in Table 1, it will be apparent to persons skilled in the art what questions apply to each situation of the taxpayer 10 corresponding to Strategy Group 2 (the taxpayer has filed a tax return for the given tax year, but additional taxes may be owed by the taxpayer even though they are not being sought by the taxing authority), Strategy Group 3 (the taxpayer has filed a tax return for the given tax year and additional taxes are being sought by the taxing authority, but the taxpayer may not believe taxes are owed), Strategy Group 4 (the taxpayer has filed a tax return for the given tax year, additional taxes are being sought by the taxing authority, and, although the taxpayer agrees the taxes are owed, the taxpayer may not be capable of paying), Strategy Group 5 (the taxpayer has filed a tax return for the given tax year and agrees with the taxing authority on the amount owed, but, even though the taxpayer has the ability to pay the taxes, the taxpayer does not intend to do so), and Strategy Group 6 (the taxpayer has filed a tax return, the taxpayer agrees with the taxing authority on the amount owed, and the taxpayer is able to and intends to pay the additional taxes being sought by the taxing authority). Depending on the situation of the taxpayer 10, it will also be apparent to persons skilled in the art what the potential solutions are for each of the Strategy Groups 2-6, namely, what the available responses to the questions that are posed to the taxpayer 10 are, so as to be targeted at dealing with the identified situation based on the circumstances of the taxpayer and the IRS, Tax, and bankruptcy court law, rules, and procedures that apply to the situation, which, as described earlier, may change from time to time.

Additional factors are also preferably provided for review of the tax strategies under consideration in step 491. These additional factors are as follows.

As shown in FIG. 6, one additional factor is based upon the personal information, values, and goals 71, which are analyzed in a step 481 to determine whether or not special circumstances are present. A step 486 provides information respecting special circumstances for review of the tax strategies under consideration in step 491.

Also, a calculation of Reasonable Collection Potential (RCP) is performed in a step 484 shown in FIG. 6 based on financial resources and obligations 72 and the amount owed by each tax year 73. Then, a step 485 determines whether or not an adjustment of the taxpayer's 10 personal finances is advisable. If so, the financial resources and obligations 72 are adjusted accordingly, and the RCP is recalculated. Conversely, if no adjustments are available or all available adjustments have been made, a step 489 provides information respecting the RCP for review of the tax strategies under consideration in step 491.

As shown in FIG. 6, the amount owed by each tax year 73 is also used in a step 483 to compare the tax debt claimed by the taxing authority to the tax liability calculated for the taxpayer 10. A step 488 provides information respecting liability for tax debt for review of the tax strategies under consideration in step 491.

Finally, the compliance status by each tax year owed 74 and stage of collection by each tax year 75 are analyzed in a step 482 shown in FIG. 6 to determine the urgency and collection stage. A step 487 provides information respecting urgency and collection stage for review of the tax strategies under consideration in step 491.

Following review of the various potential tax resolution strategies in step 491, a step 492 determines whether or not the user wants to reconsider any tax objectives. If not, the step 500 is performed to provide a report of solution analysis 150. Conversely, if the user wants to reconsider tax objectives, step 480 is repeated, and the tax objectives for the given tax year about which the taxpayer 10 is concerned are reconsidered.

The macro and micro analyses utilize algorithms to weigh segments of the taxpayer data 70, as well as the other criteria depending on the taxpayer's 10 individual situation and various other factors. For example, the taxpayer's 10 health, age, and/or other special circumstances may have an overriding impact on the range and potential success of alternative solutions. An example of such a case would be where extensive health care costs and inability to be fully employed markedly reduce a taxpayer's 10 ability to repay back taxes.

Preferably, the macro and micro algorithms 132 and 134, respectively, taxpayer data 70, other analysis databases 100, 110, 120, and 140, and any other relevant information are amended based on the experience and results from pursuing solutions under differing conditions and as changes occur in IRS, court, and other institutional practices and procedures. That is, the potential solutions and recommendations for the user to consider for implementation are preferably updated in view of a) experience with implementing tax resolution strategies using the tax resolution system 40 and b) changes in applicable IRS, Tax, and bankruptcy court law, rules, and procedures.

At the conclusion of the data analysis, the user is provided with the report of solution analysis 150, as indicated by a step 500 at the bottom of FIG. 4. This report prioritizes the potential solutions and recommendations for the user to consider for implementation. For instance, the report indicates the suitability of each potential solution based on the earlier described algorithms that take into consideration the taxpayer's 10 values, goals, and expertise; the advantages and disadvantages of each solution; the approximate time required to implement; the level of expertise needed; stress; risks of failure; and other factors that could bear on their decision respecting which potential solution to pursue.

For example, a possible solution for a taxpayer 10 in a specific case may be to submit an “offer in compromise” to the IRS. An “offer in compromise” is an IRS process for settling the amount of taxes owed. However, the taxpayer's 10 assessed level of expertise is less than that required to implement this strategy on their own. Thus, the report of solution analysis 150 would explain the potential benefits, but encourage them to seek help, for example, from a tax professional, in executing this solution.

In addition, the report of solution analysis 150 calculates the IRS's reasonable collection potential 100 and interprets what that means in terms of the agency's likely strategy for resolving the taxpayer's delinquency.

The user can save the report of solution analysis 150 in their individual secure workspace in taxpayer data, document storage 90 shown in FIG. 1.

Considered in more detail, the step 500 shown in FIG. 4 continues to the top of FIG. 5. The report of resolution analysis 150 is based on questions available to the taxpayer 10 to facilitate their own research into potential tax strategies and solutions. Once the taxpayer 10 obtains answers to their questions and receives recommendations from the tax resolution system 40 in steps 486-489 shown in FIG. 6, then the user can review tax strategies and solutions of interest in step 491. If the taxpayer 10 decides that they do not want to reconsider their tax objectives in step 492, the tax resolution system 40 produces a report of resolution analysis 150 that incorporates the tax strategies and solutions of interest in step 500.

As shown in FIG. 5, a step 510 enables the user to select a solution to implement. If they choose not to select a solution, the process ends, as indicated by a step 520. If the user selects a solution, they also can choose to make changes to their finances or circumstances prior to implementing their solution, as indicated by the step 525. Examples of pre-implementation changes may include filing past due tax returns or altering their reasonable collection potential calculation as earlier described to increase the likelihood of success of various solutions under consideration.

As shown in FIG. 5, the user is given the option of updating their data, as indicated by a step 660 which continues to the step 300 shown in FIG. 2. Not amending the data takes the user back to the step 510 shown in FIG. 5 where the user selects solution(s) to implement, at which point the user can affirm the previous solution selection or select another solution(s) and proceed to solution(s) document preparation in a step 530 without making any further changes, or electing to make changes in the steps 660 and 330, or selecting another solution(s) to implement in the step 510, or ending the process in the step 520.

Then, the user proceeds to creating their solution(s) documents starting with a step 530. A taxpayer 10 can create the solution(s) documents 550 themselves, as indicated by a step 535, or, alternatively, have a tax professional 20 do so in a step 540 by selecting such an expert from a database of tax professionals 160. In one contemplated modification, the database of tax professionals 160 may also comprise other professionals such as tax or bankruptcy lawyers. In accordance with another embodiment, the taxpayer 10 may engage a tax professional 20 to review and advise them on their taxpayer data 70, report of solution analysis 150, solution selection 510, solution(s) documents 550, and/or any other aspect of their tax resolution.

Either the taxpayer 10 or their tax professional 20 accesses the document creation tools 545 consisting of a database of solution resources 170, software to customize solution documentation 180, a database of solution documentation 190, and the taxpayer data 70 saved on the host computer 60.

The database of solution resources 170 comprises any or all of the following: white papers, glossary, frequently asked questions, live and recorded seminars, discussion groups plus other resources to help them research and understand the solution(s).

The software to customize solution documentation 180 is word processing, spreadsheet, and any other such programs needed to create and display the solution(s) documents 550.

The database of solution documentation 190 preferably contains step-by-step instructions together with word processing tools, time lines for completion, check lists, sample applications, templates, financial models, and data input forms. For example, if the taxpayer 10 wants to access their IRS tax records under the Freedom of Information Act (FOIA), they are provided detailed procedures for implementing this task along with sample completed forms, a blank form to fill out using word processing software, an explanation of the process, terms, and the reports they will receive plus tips on how to use this information in resolving their tax problem.

The user employs software to customize solution documentation 180 to modify existing files and create solution(s) documents 550. Such documentation can be saved and accessed later, printed, downloaded to a PDF, DVD or other electronic media, and/or made available to another user whom they authorize to access their workspace.

As shown in FIG. 2, the user's solution may or may not be accepted, as indicated by a step 610. If it is, the delinquent tax problem is resolved, and their need for further use of the tax resolution system 40 ends, as indicated by a step 630. If not, the user can search for another solution, as indicated by a step 650. Assuming that they decline to search for an alternative solution, the tax resolution process ends in a step 640. If they continue to search for a solution, the user is given the option of updating their taxpayer data 70 in accordance with a step 660. In this manner the tax resolution system 40 can be employed iteratively until a satisfactory resolution is found or all potential solutions are exhausted.

Whether or not the user's solution is accepted in the step 610, this outcome is preferably used in a step 620 to update and amend the tax resolution system 40 components such as the taxpayer data checker rules 80, calculation of reasonable collection potential 100, IRS, Tax, and bankruptcy court law and procedures 110, decision tree of strategic choices 120, solution algorithms 130, database of solution metrics 140, report of solution analysis 150, database of tax professionals 160, database of solution resources 170, software to customize solution documentation 180, and database of solution documentation 190.

At the user's option, their taxpayer data 70, report of solution analysis 150 and solution(s) documents 550 can be printed out, downloaded to a computer, PDF, PDA, DVD or other electronic media, or device and/or made available to another user whom they authorize to access their workspace.

In the foregoing manner, a taxpayer who is delinquent is guided to provide pertinent data and preferences to be analyzed to derive one or more potential solutions to resolve tax problems or plan a future tax strategy. The taxpayer or a tax professional is provided with the data and support information to solve tax problems and prepare documentation to implement potential solutions.

While the foregoing description has been with reference to particular embodiments of the present invention, it will be appreciated by those skilled in the art that changes in these embodiments may be made without departing from the principles and spirit of the invention. Accordingly, the scope of the present invention can only be ascertained with reference to the appended claims.

What is claimed is:

1. A tax resolution system to assist one or more users in identifying and implementing solutions to their tax delinquency problems, comprising:
a host computer;
communications software for interfacing a user computer and the host computer;
a secure workspace for data provided by a user to store taxpayer data, the taxpayer data comprising one or more of: a) personal information, values, and goals; b) financial resources and obligations; c) amount owed by each tax year; d) compliance status by each tax year owed; and e) stage of collection by each tax year owed;
solution algorithms software executed on the host computer in response to the user using the user computer to analyze the taxpayer data, the solution algorithms software comprising macro algorithms software to derive recommendations and solutions for resolving the taxpayer's overall tax delinquency and financial situation and micro algorithms software to analyze each delinquent tax year separately to derive recommendations and solutions for each such delinquent tax year; and
tax resolution software executed on the host computer in response to the user using the user computer to produce a report of solution analysis comprising one or more potential solutions;
whereby the user is enabled to select a potential solution the user wants to implement from the one or more potential solutions.

2. The system of claim 1 wherein the users comprise one of an individual and small business who is a) delinquent in their U.S. Federal personal income taxes, business income taxes, or payroll taxes; b) delinquent in their state personal income taxes, business income taxes, or payroll taxes; or c) planning the consequences of their estimated future liability for any of said taxes.

3. The system of claim 1 wherein the users comprise tax professionals who are individuals who are tax advisers or preparers or enterprises employing more than one such individual to identify and implement solutions for taxpayers who are one of an individual or small business who is a) delinquent in their U.S. Federal personal income taxes, business income taxes, or payroll taxes; b) delinquent in their state personal income taxes, business income taxes, or payroll taxes; or c) planning the consequences of their estimated future liability for any of said taxes.

4. The system of claim 1 wherein the communications software enables communication via the Internet, intranet, personal computer, or any other electronic techniques and devices that have communication capability with Internet, intranet, television, personal computers, personal data assistants (PDA's), and other personal communication equipment.

5. The system of claim 1 wherein personal information, values, and goals are the taxpayer's state of health, age, and level of expertise or interest in financial matters, as well as their stated objectives; financial resources and obligations are the taxpayer's itemization of their monthly income and expenses plus details of their assets and liabilities; amount owed by each tax year are the taxpayer's liabilities for taxes, interest, and penalties for any tax years for which they are delinquent or expect to owe in the future; compliance status by each tax year owed are the date tax returns were filed, or if they are still outstanding, and the amount of taxes paid to date, if any, on the unresolved tax years; and stage of collection by each tax year owed are the date and form of notices the taxpayer has received from the tax authority as well as any levies or liens placed on the taxpayer's income and assets.

6. The system of claim 1, further comprising software capable of being run on the host computer to calculate Reasonable Collection Potential; Internal Revenue Service (IRS), Tax, and bankruptcy court law and procedures software; decision tree of strategic choices software; and a database of solution metrics; and the solution algorithms software takes into consideration the calculation of Reasonable Collection Potential; IRS, Tax, and bankruptcy court law and procedures; decision tree of strategic choices; and database of solution metrics comprising estimates of time, expertise, cost, and parameters associated with implementing various solutions.

7. The system of claim 1 wherein the solution algorithms software comprises code to select a group of potential tax strategy solutions based on the taxpayer data and provides one or more questions relating to the selected group to enable the user to select from among the one or more potential solutions.

8. The system of claim 7 wherein the solution algorithms software comprises tax strategy mapping code to select the group of potential tax strategy solutions based on the taxpayer data, goals, and stage in the IRS collection process.

9. The system of claim 1 wherein the report of solution analysis comprises each potential solution based on solution algorithms software that takes into consideration one or more of: the taxpayer's values, goals, and expertise; the advantages and disadvantages of each solution; approximate time required to implement the potential solution; level of expertise needed; and risks of failure.

10. The system of claim 6 wherein the report of solution analysis comprises a calculation of the IRS's Reasonable Collection Potential and interpretation what that means in terms of the agency's likely strategy for resolving a tax delinquency.

11. The system of claim 1, further comprising document creation tools comprising software executed on the host computer to create and display the report of solution analysis.

12. The system of claim 11, wherein the document creation tools further comprise software executed on the host computer to access solution documentation to produce one or more solution documents in response to user selection of the potential solution.

13. The system of claim 12 wherein the document creation tools comprise programs needed to create and display the solution documents comprising word processing and spreadsheet application software.

14. The system of claim 12 wherein the solution documentation contains step-by-step instructions, time lines for completion, check lists, sample applications, templates, financial models, and data input forms.
